(19) United States
(12) Patent Application Publication
(10) Pub. No.: US 2025/0220249 A1
(43) Pub. Date: Jul. 3, 2025

(54) METHOD OF ENCODING/DECODING A LATENT REPRESENTATION BASED ON HIERARCHICAL QUANTIZATION AND COMPUTER READABLE MEDIUM RECORDING THEREOF

(71) Applicant: Electronics and Telecommunications Research Institute, Daejeon (KR)

(72) Inventors: JooYoung LEE, Daejeon (KR); Youn Hee KIM, Daejeon (KR); Se Yoon JEONG, Daejeon (KR); Jin Soo CHOI, Daejeon (KR); Jung Won KANG, Daejeon (KR)

(73) Assignee: Electronics and Telecommunications Research Institute, Daejeon (KR)

(21) Appl. No.: 18/962,612

(22) Filed: Nov. 27, 2024

(30) Foreign Application Priority Data
Nov. 27, 2023 (KR) 10-2023-0167193
Nov. 22, 2024 (KR) 10-2024-0168703

(51) Int. Cl. H04N 19/91; H04N 19/117; H04N 19/124; H04N 19/30

(52) U.S. Cl. CPC H04N 19/91; H04N 19/117; H04N 19/124; H04N 19/30

(57) ABSTRACT

A latent representation encoding method based on hierarchical quantization according to the present disclosure may include quantizing a latent representation for a current layer; and entropy-encoding a quantized latent representation. In this case, quantizing the latent representation includes determining quantization intervals for the current layer, and a size of the quantization intervals of the current layer may be the same as a size of a quantization interval to which the latent representation within a previous layer belongs.

### TECHNICAL FIELD

The present disclosure relates to a method and a device for encoding/decoding a latent representation based on hierarchical quantization.

### BACKGROUND ART

Through various studies on a neural network-based compression method, a neural network-based compression codec shows improved performance compared to the existing codec such as BPG and JPEG2000. Currently, research is actively being conducted not only to improve the performance of a neural network-based image compression codec, but also to improve the usability (or functionality) of a neural network-based image compression codec.

According to the necessity, research on a neural network-based progressive image compression method is actively being conducted so that a single bitstream can be utilized according to various transmission or consumption environments.

### DISCLOSURE

### Technical Problem

The present disclosure is to provide a hierarchical quantization method for efficient encoding/decoding of a latent representation and a device therefor.

The present disclosure is to provide a method for determining a boundary of quantization intervals based on a learned quantization step size vector.

The present disclosure is to provide a method for adjusting quantization intervals that remove an extremely narrow quantization interval.

The present disclosure is to provide a method for performing component-wise quantization/dequantization of a latent representation.

The technical objects to be achieved by the present disclosure are not limited to the above-described technical objects, and other technical objects which are not described herein will be clearly understood by those skilled in the pertinent art from the following description.

### Technical Solution

A latent representation encoding method based on hierarchical quantization according to the present disclosure may include quantizing a latent representation for a current layer; and entropy-encoding a quantized latent representation. In this case, quantizing the latent representation includes determining quantization intervals for the current layer, and a size of the quantization intervals of the current layer may be the same as a size of quantization intervals to which the latent representation within a previous layer belongs.

In a latent representation encoding method based on hierarchical quantization according to the present disclosure, a boundary of a quantization interval may be determined based on a temporary boundary derived based on a quantization step size vector.

In a latent representation encoding method based on hierarchical quantization according to the present disclosure, when the temporary boundary exceeds a bottom boundary or a top boundary of the previous layer, a boundary of the quantization interval may be set as the bottom boundary or the top boundary of the previous layer.

In a latent representation encoding method based on hierarchical quantization according to the present disclosure, the quantization step size vector may be different according to a layer.

In a latent representation encoding method based on hierarchical quantization according to the present disclosure, a bottom boundary and a top boundary of a quantization interval for a first layer may be determined based on a quantization step size vector for the first boundary and the total number of layers.

In a latent representation encoding method based on hierarchical quantization according to the present disclosure, quantizing the latent representation further includes adjusting an interval of the quantization intervals, and the adjustment may be performed when there is a quantization interval whose ratio is smaller than a threshold value.

In a latent representation encoding method based on hierarchical quantization according to the present disclosure, adjusting an interval of the quantization intervals may remove a quantization interval whose ratio is smaller than a threshold value and adjust a boundary of residual quantization intervals.

In a latent representation encoding method based on hierarchical quantization according to the present disclosure, a boundary of residual quantization intervals may be changed to an extended boundary, and the extended boundary may be derived based on a median value in a previous layer and an extended quantization step size vector.

In a latent representation encoding method based on hierarchical quantization according to the present disclosure, the quantized latent representation may be obtained by quantizing an unbiased latent representation, and the unbiased latent representation may be derived by subtracting an average value from the latent representation.

In a latent representation encoding method based on hierarchical quantization according to the present disclosure, the method further includes filtering component values of the latent representation, and the quantization may be performed only on components selected through the filtering.

In a latent representation encoding method based on hierarchical quantization according to the present disclosure, the entropy encoding may be performed based on a quantized PMF-approximate value for each of the quantization intervals, and the PMF-approximate value for a quantization interval may be calculated based on a boundary of an interval to which the latent representation within the previous layer belongs and a boundary of the quantization interval.

A latent representation decoding method based on hierarchical quantization according to the present disclosure may include entropy-decoding a quantized latent representation for a current layer; and dequantizing the quantized latent representation. In this case, dequantizing the quantized latent representation includes determining quantization intervals for the current layer, and a size of the quantization intervals of the current layer may be the same as a size of a quantization interval to which the latent representation within a previous layer belongs.

In addition, according to the present disclosure, a computer readable recording medium storing instructions for performing the latent representation encoding/decoding method based on hierarchical quantization or data generated by the encoding method may be provided.

### Technical Effect

According to the present disclosure, encoding/decoding efficiency of a latent representation may be improved based on a hierarchical quantization method.

According to the present disclosure, a method for determining a boundary of quantization intervals based on a learned quantization step size vector may be provided.

According to the present disclosure, encoding/decoding efficiency may be improved by removing an extremely narrow quantization interval through the adjustment of quantization intervals.

According to the present disclosure, encoding/decoding efficiency may be improved by performing component-wise quantization/dequantization of a latent representation.

### BRIEF DESCRIPTION OF DRAWINGS

FIG. 1 shows a conceptual diagram of progressive image coding according to an embodiment of the present disclosure.

FIG. 2 illustrates hierarchical quantization according to an embodiment of the present disclosure.

FIG. 3 is a block diagram of a hierarchical quantizer according to the present disclosure.

FIG. 4 illustrates quantization intervals between two adjacent layers.

FIG. 5 is a diagram comparing before and after applying a quantization interval boundary adjustment method according to the present disclosure.

FIG. 6 is a flowchart of a hierarchical quantization method according to an embodiment of the present disclosure.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The present disclosure provides a method for performing hierarchical quantization of a transformed latent representation in a neural network-based progressive image encoding/decoding method. Hereinafter, a method for performing hierarchical quantization according to the present disclosure is described in detail.

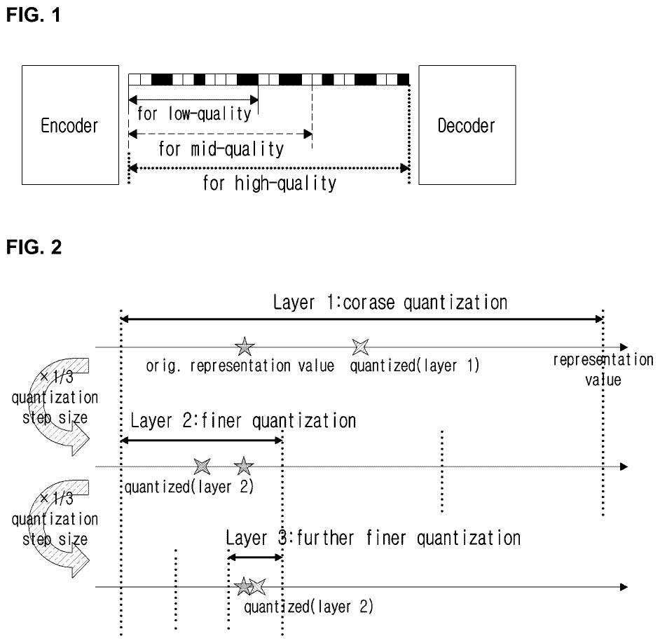

FIG. 1 shows a conceptual diagram of progressive image coding according to an embodiment of the present disclosure.

As in an example shown in FIG. 1, progressive image coding refers to a compression method in which a single image is compressed into a plurality of quality and the compressed data of a plurality of quality is generated as a single bitstream.

In other words, a bitstream generated based on progressive image coding may include image data of a plurality of quality.

While an image of quality suitable for a content usage environment is provided by including the image data of a plurality of quality in a single bitstream, high compression efficiency may be provided compared to compressing a plurality of quality individually.

Meanwhile, one image may be composed of a plurality of layers with different quality. A unique index (or identifier) may be allocated to each layer. In this case, an index with a smaller value than a high-quality layer may be allocated to a low-quality layer.

In encoding/decoding a plurality of layers, hierarchical quantization may be applied. Hierarchical quantization may mean that a quantization step (i.e., a quantization parameter) is gradually reduced according to a layer. Accordingly, each layer may be called a quantization layer.

FIG. 2 illustrates hierarchical quantization according to an embodiment of the present disclosure.

As shown in an example in FIG. 2, a relatively wide quantization step may be set for a low-quality layer, while a relatively narrow quantization step may be set for a high-quality layer.

Meanwhile, information about a quantization step may be encoded and transmitted through a bitstream. In this case, a quantization step in a low-quality layer may be encoded, and for a high-quality layer, information for deriving the quantization step of a high-quality layer from a quantization step in a previous layer (i.e., a low-quality layer) may be encoded.

As an example, information showing a difference between the quantization step of a current layer and the quantization interval of a previous layer may be encoded.

Alternatively, when the quantization step of a current layer is 1/N times the quantization step of a previous layer, information showing an integer N may be encoded.

Alternatively, a quantization step may be derived according to a predefined method in an encoder and a decoder. As an example, when a DPICT method based on Trit-Planes is used, the quantization step of a l-th layer (here, l is an integer greater than or equal to 1) may be set to be ⅓ times the quantization step of a previous layer (i.e., a (l−1)-th layer). Accordingly, only a quantization step in a layer with the smallest index may be encoded/decoded, and a quantization step in the remaining layers may be derived based on the quantization step of a previous layer.

Meanwhile, the present disclosure proposes a method for performing hierarchical quantization by using a quantization step learned based on a neural network, instead of a method for determining a quantization step for each layer (i.e., a handcrafted quantization method). A hierarchical quantizer that performs hierarchical quantization, which is proposed in the present disclosure, may be referred to as DeepHQ.

Meanwhile, in an encoder network using a hierarchical quantizer according to the present disclosure, an input image may be transformed into latent representation y. Afterwards, latent representation y may be transformed into additional information z through a hyper-encoder network.

In addition, a hyper-encoder network may obtain p and a, estimates for the distribution parameters of latent representation y, from additional information z. Here, p represents an estimate for the average value of distribution of latent representation y, and a represents an estimate for the standard deviation of y distribution. The type of distribution of latent representation y may be predefined and used, and as an example, Gaussian distribution may be used. Accordingly, distribution parameters may also be called a Gaussian distribution parameter.

In addition, a hierarchical quantizer according to the present disclosure may be used not only on an encoder side, but also on a decoder side. In this case, a decoder may use the inverse vector of a quantization step size vector used in an encoder.

As an example, Equation 1 shows an example in which dequantization is performed in a decoder.

$${x}_{l}^{′} = De ( {\hat{y}}_{l} \cdot {Δ}_{l}^{inv} ) , \qquad [ Equation 1 ]$$

$$with$$

$${\hat{y}}_{l} = [ y / {Δ}_{l} ]$$

In Equation 1, Δₗ represents a quantization step size vector, and Δₗ^{inv} represents a dequantization step size vector. [·] represents a rounding operation.

Meanwhile, in the present disclosure, according to a layer, a different quantization (dequantization) step size vector Δₗ(Δₗ^{inv}) may be used. In other words, each layer may be quantized (dequantized) based on a dedicated quantization (dequantization) step size vector Δₗ(Δₗ^{inv}).

In addition, each element of a quantization (dequantization) step size vector Δₗ(Δₗ^{inv}) may correspond to the specific channel of latent representation y. In other words, C_{y}, the total number of elements forming a quantization (dequantization) step size vector Δₗ(Δₗ^{inv}), may be the same as the total number of channels of latent representation y.

A quantization step size vector may be derived/optimized by learning. In order to optimize a quantization step size vector, a loss function according to Equation 2 below may be used.

$$L = {\sum }_{l} {R}_{l} + {λ}_{l} * {D}_{l} \qquad [ Equation 2 ]$$

In Equation 2 above, l represents the index of a layer.

In addition, Rₗ represents a cross entropy (an estimated bit rate), and Di represents a reconstruction error.

λₗ represents a balance parameter, and may be derived for each layer as in Equation 3 below.

$${λ}_{l} = 0.2 * {2}^{l - 8} \qquad [ Equation 3 ]$$

Meanwhile, in order to approximate the distribution of a quantized latent representation (i.e., y/Δₗ), at least one of μ/Δₗ or σ/Δₗ may be used to derive cross entropy Rₗ.

Hereinafter, a hierarchical quantizer according to the present disclosure is described in detail.

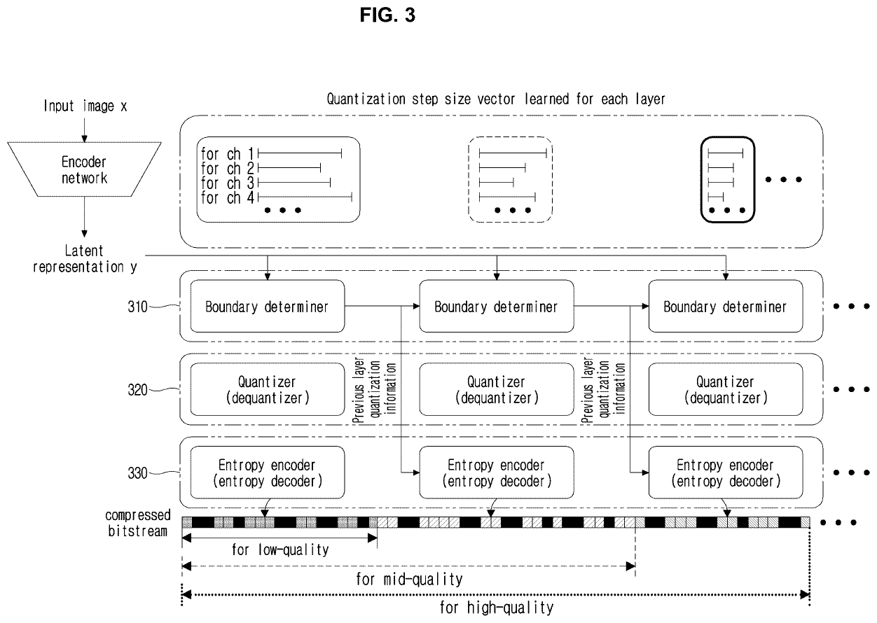

FIG. 3 is a block diagram of a hierarchical quantizer according to the present disclosure.

Referring to FIG. 3, a hierarchical quantizer according to the present disclosure may include a boundary determiner 310, a quantizer/a dequantizer 320, and an entropy encoder/an entropy decoder 330.

A boundary determiner 310 determines the boundary of quantization intervals for each layer.

When the boundary of quantization intervals is determined by a boundary determiner 310, a quantizer 320 performs quantization on a latent representation (specifically, an unbiased latent representation) according to determined quantization intervals.

A dequantizer 320 may perform dequantization on an entropy-decoded quantized latent representation.

An entropy encoder/an entropy decoder 330 may perform entropy encoding/entropy decoding on a quantized latent representation.

In an example shown in FIG. 3, a quantizer and an entropy encoder may be included when a hierarchical quantizer is used on an encoding side, and a dequantizer and an entropy decoder may be included when a hierarchical quantizer is used on a decoding side.

Meanwhile, a hierarchical quantizer according to the present disclosure may target a non-aggressive model.

A hierarchical quantizer according to the present disclosure may quantize latent representation y by using a different quantization (dequantization) step size vector for each layer.

A hierarchical quantizer according to the present disclosure may utilize a learned quantization step size vector for each layer. In this case, in order to quantize latent representation y, a different quantization (dequantization) step size vector may be used for each layer. In addition, in the present disclosure, only an essential representation element may be compressed for each layer, improving image compression efficiency.

Equation 4 shows the overall quantization/dequantization process.

$${{y}^{⌣}}_{l}^{final} = ( {{y}^{⌣}}_{l}^{*} + μ ) / {Δ}_{l} * {Δ}_{l}^{inv} \qquad [ Equation 4 ]$$

$$with$$

$${{y}^{⌣}}_{l}^{*} = {Q}_{l} ( {y}^{*} )$$

In Equation 4, l represents the index of a layer.

y̌ₗ^{final} may represent a dequantized latent representation. A dequantized latent representation may be used to reconstruct a latent representation in a decoder.

y̌ₗ* represents a quantized latent representation, and may be obtained by quantizing y*. Meanwhile, a quantized latent representation may also be called an intermediate reconstructed latent representation.

Meanwhile, y* represents an unbiased latent representation. Unbiased latent representation y* may be derived by shifting latent representation y by Gaussian parameter μ, as in Equation 5 below. In other words, an unbiased latent representation may be derived by subtracting μ, the average value of a latent representation, from latent representation y.

$${y}^{*} = y - μ \qquad [ Equation 5 ]$$

Quantized latent representation y̌ₗ* may be obtained by inputting unbiased latent representation y* into quantization function Qₗ. Here, function Qₗ may be configured to quantize/dequantize unbiased latent representation y* more finely as the number of layers increases.

Δₗ represents a quantization step size vector, and Δₗ^{inv} represents a dequantization step size vector.

Meanwhile, dequantization interval size vector Δₗ^{inv} may be used only to derive dequantized latent representation y̌ₗ^{final}. In other words, dequantization interval size vector Δₗ^{inv} is used only to derive dequantized latent representation y̌ₗ^{final} from intermediate latent reconstruction latent representation y̌ₗ* and is not used in other steps of progressive coding.

Quantization and dequantization are performed by an array operation. However, for convenience of a description, embodiments described below will be described based on quantization and dequantization for a component included in an array.

When y_{l,i}*, the component value of an unbiased latent representation, belongs to the k-th (k is an integer including 0) quantization interval I_{l,i}^{k}, y̌_{l,i}*, the component value of a quantized latent representation, may be derived as in Equation 6 below.

$${{y}^{⌣}}_{l , i}^{*} = {Q}_{l} ( {y}_{i}^{*} ) = {v}_{l , i}^{k} , \qquad [ Equation 6 ]$$

$$if {y}_{i}^{*} ∈ {I}_{l , i}^{k}$$

$$with$$

$${v}_{l , i}^{k} = ( {b}_{l , i}^{k} + {b}_{l , i}^{k + 1} ) / 2 , {I}_{l , i}^{k} = [ {b}_{l , i}^{k} , {b}_{l , i}^{k + 1} )$$

In Equation 6 above, l may represent the index of a layer, and i may represent the index of a component. In addition, k may represent the index of a quantization interval.

In other words, as in Equation 3, y̌_{l,i}*, the component value of a quantized latent representation, may be derived as v_{l,i}^{k}, the median value of k-th quantization interval I_{l,i}^{k}, that includes a corresponding component. Here, the median value of a k-th quantization interval may be derived by dividing the sum of b_{l,i}^{k}, the minimum value of k-th quantization interval I_{l,i}^{k}, and b_{l,i}^{k+1}, the minimum value of next quantization interval (i.e., a k+1-th quantization interval) I_{l,i}^{k+1}, by 2.

Meanwhile, k may be an integer having a value from (−(K−1)/2) to ((K−1)/2). Here, K may represent the total number of quantization intervals.

Meanwhile, in order to entropy encode/decode quantized latent representation y̌_{l,i}*, a probability mass function (PMF)-approximation value for the index k and layer l of a quantization interval may be used.

Here, a PMF-approximation value may be derived as in Equation 7 below.

$$P ( {y}_{i}^{*} ∈ {I}_{l , i}^{k} \vert {y}_{i}^{*} ∈ {I}_{l - 1 , i}^{s} ) = \frac{Φ ( {b}_{l , i}^{k + 1} ) - Φ ( {b}_{l , i}^{k} )}{Φ ( {b}_{l - 1 , i}^{s + 1} ) - Φ ( {b}_{l - 1 , i}^{s} )} \qquad [ Equation 7 ]$$

In Equation 7 above, PMF-approximation value P represents a probability that unbiased latent representation yᵢ* in a current layer (i.e., a l-th layer) exists within quantization interval I_{l-1,i}^{s}, when unbiased latent representation yᵢ* in a previous layer (i.e., a l−1-th layer) is determined to exist within quantization interval I_{l,i}^{k}.

In addition, ϕ represents a cumulative distribution function.

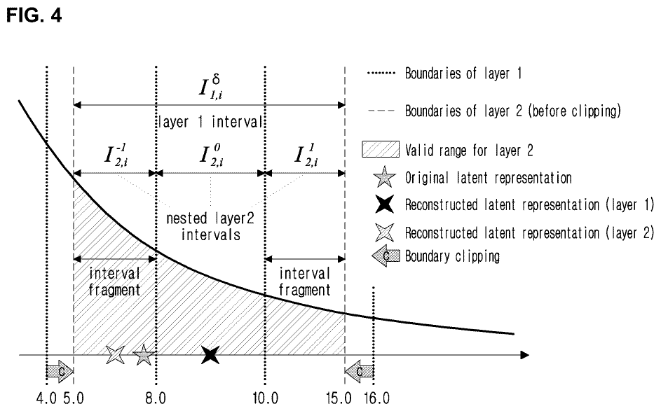

FIG. 4 illustrates quantization intervals between two adjacent layers.

As in a shown example, the size of quantization intervals of a current layer (i.e., the sum of sizes of each quantization interval) may be the same as the size of a quantization interval to which an unbiased latent representation in a previous layer belongs.

In an example shown in FIG. 4, it was illustrated that the unbiased latent representation of Layer 1 exists in quantization interval I_{1,i}^{s}. Accordingly, PMF approximation value P for quantization interval I_{2,i}⁻¹ with an index of −1 may be derived as {ϕ(8.0) −φ(5.0)}/{ϕ(15.0)−ϕ(5.0)}.

Meanwhile, quantization step size vector Δ_{l,i} may be used to determine the value of b_{l,i}, a boundary between quantization intervals (i.e., the minimum value of a quantization interval). Specifically, b_{l,i}^{k}, a boundary between a (k−1)-th quantization interval and a k-th quantization interval (i.e., the minimum value of a k-th quantization interval), may be derived as in Equation 8 below.

$${b}_{l , i}^{k} = \{ \begin{matrix}{LB}_{l , i} , & if {c}_{l , i}^{k} < {LB}_{l , i} \\ {UB}_{l , i} , & else if {c}_{l , i}^{k} > {UB}_{l , i} \\ {c}_{l , i}^{k} , & otherwise\end{matrix} \qquad [ Equation 8 ]$$

$$with$$

$${c}_{l , i}^{k} = ( k = 0.5 ) \times {Δ}_{l , i} + {v}_{l - 1 , i}^{s} ,$$

$${LB}_{l , i} = {b}_{l - 1 , i}^{s} ,$$

$${UB}_{l , i} = {b}_{l - 1 , i}^{s + 0}$$

In Equation 8 above, the boundary of a quantization interval may be derived based on temporary boundary value c_{l,i}^{k}. Meanwhile, a distance between two neighboring temporary boundary values c_{l,i}^{k} and c_{l,i}^{k+1} (or c_{l,i}^{k-1} and c_{l,i}^{k}) is the same as quantization step size vector Δ_{l,i}. Accordingly, temporary boundary value c_{l,i}^{k} may be derived based on quantization step size vector Δ_{l,i}.

Meanwhile, v_{l-1,i}^{s} represents a center position between the 0-th temporary boundary value c_{l,i}⁰ and first boundary value c_{l,i}¹ (or, between b_{l,i}⁰ and b_{l,i}¹) in a (l−1)-th layer. In other words, v_{l-1,i}^{s} may be the center value of a first quantization interval in a previous layer.

Meanwhile, the value of v_{0,i}^{s} for a first quantization layer may be set as 0.

When temporary boundary value c_{l,i}^{k} exists outside bottom boundary value LB_{l,i} and top boundary value UB_{l,i}, a clipping process may be applied. In other words, when temporary boundary value c_{l,i}^{k} is out of bottom boundary value LB_{l,i} and top boundary value UB_{l,i}, boundary value b_{l,i}^{k} may be determined as bottom boundary value LB_{l,i} or top boundary value UB_{l,i}. Through a clipping process, redundancy between layers may be removed in terms of compression.

Each of bottom boundary value LB_{l,i} and top boundary value UB_{l,i} may be set as b_{l-1,i}^{k} and b_{l-1,i}^{k+1}, which are boundary values for I_{l-1,i}^{s}, the quantization interval of a previous layer. Here, I_{l-1,i}^{s}, a quantization interval in a previous layer, may represent an interval that includes unbiased latent representation yᵢ*.

Meanwhile, each of bottom boundary value LB_{l,i} and top boundary value UB_{l,i} for a first layer may be set as in Equation 9 below.

$${LB}_{1 , i} = - {Δ}_{1 , i} \times ( \frac{K}{2} ) \qquad [ Equation 9 ]$$

$${UB}_{1 , i} = {Δ}_{1 , i} \times ( \frac{K}{2} )$$

Meanwhile, according to the above-described embodiment, when the boundary of quantization intervals is determined, the size of some quantization intervals may be extremely small. As an example, after a quantization layer is determined based on the center point of a previous quantization layer, the size of the remaining quantization interval fragments (i.e., a first quantization interval and a last quantization interval) may be extremely small.

When the size of a quantization interval is extremely small, an error due to quantization may be reduced, but the amount of bit consumption may increase, thereby lowering the overall compression efficiency.

Accordingly, in the present disclosure, a method for adjusting a quantization interval boundary is proposed that compares the ratio of a quantization interval with a threshold value, removes a quantization interval whose ratio is smaller than a threshold value and expands the boundary of the remaining quantization intervals.

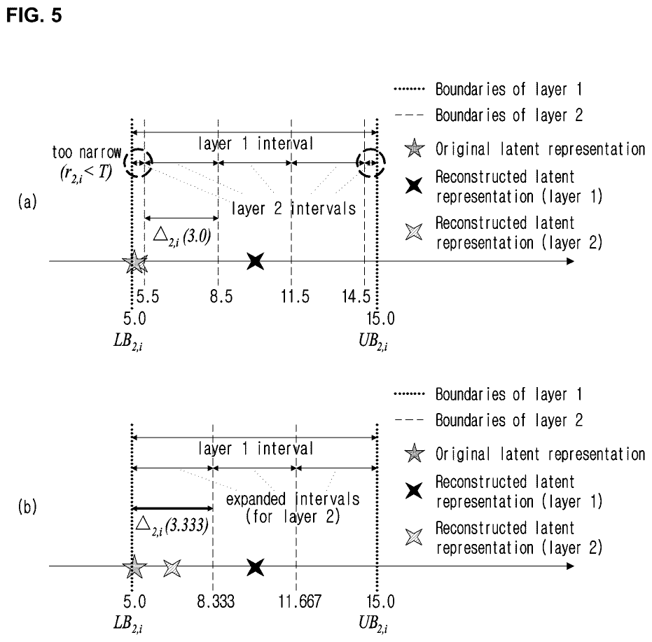

FIG. 5 is a diagram comparing before and after applying a quantization interval boundary adjustment method according to the present disclosure.

FIG. 5(a) is an example before quantization interval boundary adjustment is performed, and FIG. 5(b) is an example after quantization interval boundary adjustment is performed.

As in an example shown in FIG. 5, quantization interval adjustment may be performed to remove an extremely small interval. Meanwhile, while removing an extremely small interval, the boundary of the remaining quantization intervals may be extended. Meanwhile, quantization intervals to be removed may be the first and the last among the quantization intervals.

Adjusting the boundary of a quantization interval may be performed based on Equation 10 below.

$${\dot{b}}_{l , i} = \{ \begin{matrix}{\ddot{b}}_{l , i} , & if {r}_{l , i} < T \\ {b}_{l , i} , & otherwise\end{matrix} \qquad [ Equation 10 ]$$

$$with$$

$${r}_{l , i} = \frac{( {v}_{l - 1 , i}^{s} - {LB}_{l , i} - 0.5 \times {Δ}_{l , i} ) mod {Δ}_{l , i}}{{Δ}_{l , i}}$$

In Equation 10 above, r_{l,i} represents the ratio of a quantization interval, and T represents a threshold value. Here, threshold value T may be predefined. As an example, T may be set as 0.3, but is not limited thereto.

b̅_{l,i} represents an extended boundary vector, and may be derived based on Equation 11 below.

$${\ddot{b}}_{l , i} = ( k - 0.5 ) \times {\ddot{Δ}}_{l , i} + {{y}^{⌣}}_{l - 1 , i}^{*} , \qquad [ Equation 11 ]$$

$$with$$

$${\ddot{Δ}}_{l , i} = \frac{{UB}_{l , i} - {LB}_{l , i}}{{N}^{{b}_{l , i}} - 2}$$

In Equation 11, \ddot{Δ}l,i represents an extended quantization step size. N^{b}^{_{l,i}} refers to the number of sub-intervals belonging to an original boundary vector b_{l,i}.

Meanwhile, the size of first and last quantization intervals may be the same each other. It is because a quantization interval is set symmetrically around v_{l-1,i}^{s}, the median value of a previous layer (i.e., (LB_{l,i}+UB_{l,i})/2).

\dot{b}_{l,i}, the final boundary vector of a quantization interval, may be adaptively determined according to r_{l,i}, the ratio of a quantization interval. Specifically, r_{l,i} refers to the ratio of sizes of first and last quantization intervals belonging to b_{l,i} compared to the size of Δ_{l,i}, and the value of this r_{l,i} may be compared with a threshold value to determine whether to use an extended boundary. When r_{l,i} the ratio of a first or last quantization interval, is less than a threshold value, final boundary vector \dot{b}_{l,i} may be set as extended boundary vector b̅_{l,i}.

Otherwise, a first or last quantization interval may be maintained. In other words, final boundary vector \dot{b}_{l,i} may maintain the original boundary vector b_{l,i}.

Meanwhile, when quantization interval adjustment is performed, as in an example shown in FIG. 5, within the range of LB_{l,i} and UB_{l,i}, there may be at least one interval having an extended step size \ddot{Δ}_{l,i} according to the calculation method of the extended boundary vector \ddot{b}_{l,i}.

In entropy encoding/decoding a quantization representation, selective compression of representations (SCR) is effective in compression efficiency and reducing decoding time in variable-rate compression by selectively compressing only an essential representation according to a target compression level. Accordingly, the present disclosure also proposes a selective quantization method for an unbiased latent representation.

Equation 12 represents a selective quantization method for an unbiased latent representation.

$${{y}^{⌣}}_{l}^{*} = Re ( {Q}_{l} ( {〈 {y}^{*} 〉}_{l} ) , m ( \hat{z} , l ) ) , \qquad [ Equation 12 ]$$

$$with$$

$${〈 {y}^{*} 〉}_{l} = M ( {y}^{*} , m ( \hat{z} , l ) )$$

In Equation 12, m(ž, l) represents a 3D binary mask. A 3D binary mask may be generated from a quantized hyperprior representation ž for a l-th layer. A 3D binary mask may indicate which components of unbiased latent representation y* are to be compressed and which are not to be compressed.

M( ) represents a selection operator. Specifically, 3D binary mask m(ž, l) may be applied to unbiased latent representation y* to extract only components determined as a compression target.

[symbol] y* [symbol] ₗ represents a set composed of components selected in a l-th layer.

Re( ) represents an operator that reshapes set [symbol] y*ₗ [symbol] . Specifically, through Re( ), set [symbol] y* [symbol] ₗ may be transformed from a one-dimensional form to a three-dimensional form. Meanwhile, a 3D binary mask m(ž, l) may be used to reshape set [symbol] y* [symbol] ₗ.

Meanwhile, quantization function Qₗ is basically the same as described through Equation 4, but each of LB_{l,i} and UB_{l,i} may be set as the LB_{1,i} and UB_{1,i} of a quantization interval included first in a l-th layer.

Meanwhile, the generation of a fully generalized mask of an original SCR may not be suitable for progressive coding. Accordingly, the present disclosure proposes a method for generating a 3D binary mask to ensure that all elements selected from a lower layer included in a higher layer are included in a higher layer.

Specifically, a 3D binary mask may be generated according to Equation 13 below.

$$m ( \hat{z} , l ) = m ( \hat{z} , l - 1 ) + \{ 0 - m ( \hat{z} , l - 1 ) \} ⊙ {m}^{′} ( \hat{z} , l ) \qquad [ Equation 13 ]$$

In Equation 13, intermediate binary mask m′(ž, l) may be generated from quantized hyperprior representation ž without considering hierarchical quantization according to an original SCR model. Meanwhile, based on an original SCR model, a method for obtaining a 3D binary mask may refer to the following reference.

Jooyoung Lee, Seyoon Jeong, and Munchurl Kim. Selective compression learning of latent representations for variable-rate image compression. In Thirty-Sixth Conference on Neural Information Processing Systems, 2022.

In addition, ⊙ represents an element-wise multiplication operation.

As in an example shown in Equation 12, in order to generate 3D binary mask m(ž, l), m(ž, l−1), a 3D binary mask in a previous layer, may be used. In other words, m(ž, l), the 3D binary mask of a current layer, may be generated by performing update for adding {1−m(ž, l−1)}⊙m′(ž, l) to m(ž, l−1), the 3D binary mask of a previous layer.

Through this, a progressive (or, inclusive) relationship from a lower layer to a higher layer may be maintained. Here, a progressive (or, inclusive) relationship represents that components selected from a lower layer are necessarily selected from a higher layer.

Meanwhile, m(ž, l), a binary mask for a first layer (i.e., l=1), may be set to be the same as intermediate binary mask m′(ž, l).

In order to support more fine-grained progressive image compression, component-wise progressive image compression may also be supported.

Specifically, when component-wise progressive image compression is supported, a component with higher Gaussian distribution parameter σ (i.e., a component with large standard deviation) may be encoded/decoded earlier. In other words, when component-wise progressive image compression is supported, encoding/decoding may proceed in the descending order of estimated a values of each component.

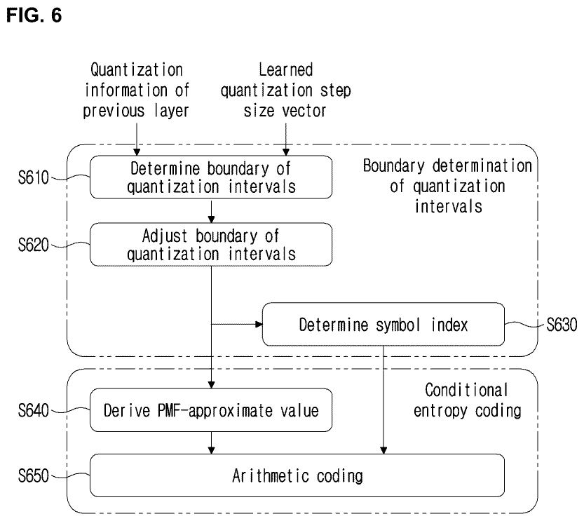

FIG. 6 is a flowchart of a hierarchical quantization method according to an embodiment of the present disclosure.

A hierarchical quantization method may largely include a step of determining the boundary of quantization intervals and a conditional entropy coding step.

First, based on quantization information in a lower layer (or a previous layer) and a learned quantization step size vector, the boundary of quantization intervals may be determined S610. In this case, determining the boundary of quantization intervals may be performed component-wise. In other words, the boundary of quantization intervals may be determined independently for each component of a latent representation. Determining the boundary of a quantization interval is described through Equation 8.

The quantization information of a previous layer may include information on the quantization interval of a previous layer including an unbiased latent representation component value, and information on a quantization interval may include at least one of the boundary value information of a quantization interval (i.e., a bottom boundary value and a top boundary value) or the intermediate value information of a quantization interval.

Meanwhile, for a first layer, the boundary of a quantization interval may be determined without using the quantization information of a previous layer.

When the boundary of quantization intervals is determined, the boundary adjustment of quantization intervals may be performed S620. Adjusting the boundary of quantization intervals is described in detail through an example in Equation 9 and Equation 10. Meanwhile, a step of adjusting the boundary of quantization intervals may be selectively performed according to whether the ratio of a first or last quantization interval size is smaller than a threshold value.

Based on calculated boundaries, interval indexes to which unbiased latent representation values belong may be determined S630.

A PMF-approximation value for each quantization interval within a valid quantization range may be derived S640. Deriving a PMF-approximation value for a quantization interval is described through Equation 7. Meanwhile, a PMF-approximation value may be calculated component-wise.

Afterwards, based on the interval index of latent representations and a PMF-approximation value, a bitstream may be generated by performing arithmetic coding for a quantized latent representation S650.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. A latent representation encoding method based on a hierarchical quantization, the method comprising:
quantizing a latent representation for a current layer; and
entropy-encoding a quantized latent representation,
wherein quantizing the latent representation includes determining quantization intervals for the current layer,
wherein a size of the quantization intervals of the current layer is equal to a size of a quantization interval to which the latent representation within a previous layer belongs.

2. The method of claim 1, wherein:
a boundary of a quantization interval is determined based on a temporary boundary derived based on a quantization step size vector.

3. The method of claim 2, wherein:
when the temporary boundary exceeds a bottom boundary or a top boundary of the previous layer, the boundary of the quantization interval is set as the bottom boundary or the top boundary of the previous layer.

4. The method of claim 2, wherein:
the quantization step size vector is different according to a layer.

5. The method of claim 2, wherein:
a bottom boundary and a top boundary of a quantization interval for a first layer is determined based on a quantization step size vector for the first boundary and a total number of layers.

6. The method of claim 1, wherein:
quantizing the latent representation further includes adjusting an interval of the quantization intervals,
the adjustment is performed when there is a quantization interval where a ratio is smaller than a threshold value.

7. The method of claim 6, wherein:
adjusting the interval of the quantization intervals removes the quantization interval where the ratio is smaller than the threshold value and adjusts a boundary of residual quantization intervals.

8. The method of claim 7, wherein:
the boundary of the residual quantization intervals is changed to an extended boundary,
the extended boundary is derived based on a median value in the previous layer and an extended quantization step size vector.

9. The method of claim 1, wherein:
the quantized latent representation is obtained by quantizing an unbiased latent representation,
the unbiased latent representation is derived by subtracting an average value from the latent representation.

10. The method of claim 1, wherein:
the method further includes filtering component values of the latent representation, the quantization is performed only on components selected through the filtering.

11. The method of claim 1, wherein:
the entropy encoding is performed based on a quantized PMF-approximate value for each of the quantization intervals,
the PMF-approximate value for a quantization interval is calculated based on a boundary of the interval to which the latent representation within the previous layer belongs and a boundary of the quantization interval.

12. A latent representation decoding method based on a hierarchical quantization, the method comprising:
entropy-decoding a quantized latent representation for a current layer; and
dequantizing the quantized latent representation,
wherein dequantizing the quantized latent representation includes determining quantization intervals for the current layer,
wherein a size of the quantization intervals of the current layer is equal to a size of a quantization interval to which the latent representation within a previous layer belongs.

13. A computer readable recording medium recording a latent representation encoding method based on a hierarchical quantization, the computer readable recording medium comprising:
quantizing a latent representation for a current layer; and
entropy-encoding a quantized latent representation,
wherein quantizing the latent representation includes determining quantization intervals for the current layer,
wherein a size of the quantization intervals of the current layer is equal to a size of a quantization interval to which the latent representation within a previous layer belongs.
